(19) United States
(12) Patent Application Publication
(10) Pub. No.: US 2014/0080691 A1
(43) Pub. Date: Mar. 20, 2014

(54) CHARGING MEMBER, PROCESS CARTRIDGE AND ELECTROPHOTOGRAPHIC APPARATUS

(71) Applicant: CANON KABUSHIKI KAISHA, Tokyo (JP)

(72) Inventors: Masahiro Kurachi, Fujisawa-shi (JP); Masataka Kodama, Mishima-shi (JP); Noriyuki Doi, Numazu-shi (JP); Noriko Suzumura, Mishima-shi (JP); Hiroki Masu, Numazu-shi (JP); Noriaki Kuroda, Suntou-gun (JP)

(73) Assignee: CANON KABUSHIKI KAISHA, Tokyo (JP)

(21) Appl. No.: 14/080,790

(22) Filed: Nov. 14, 2013

Related U.S. Application Data
(63) Continuation of application No. PCT/JP2013/003093, filed on May 15, 2013.

(30) Foreign Application Priority Data
May 22, 2012 (JP) 2012-116564

(51) Int. Cl. B05C 1/08; G03G 15/02

(52) U.S. Cl. CPC G03G 15/0233
USPC 492/18; 399/176

(57) ABSTRACT

The present invention provides a charging member that suppresses abnormal discharge which induces charging unevenness, and that has little contamination on a surface layer, to thereby enable uniform charging over a long period. The charging member includes a substrate, an elastic layer and a surface layer, wherein the surface layer contains a polymer compound having constitutional units represented by the following general formula (1), chemical formula (2) and general formula (3), and having a Si—O—Ti bond, a Ti—O-M bond and a Si—O-M bond. M is any atom selected from the group consisting of V, Nb and W.

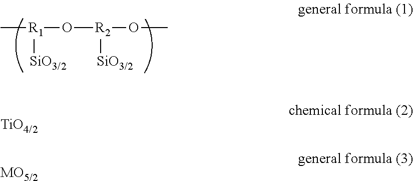

### CROSS-REFERENCE TO RELATED APPLICATIONS

This application is a continuation of International Application No. PCT/JP2013/003093, filed May 15, 2013, which claims the benefit of Japanese Patent Application No. 2012-116564, filed May 22, 2012.

### BACKGROUND OF THE INVENTION

### Field of the Invention

The present invention relates to a charging member for use in contact charging of an electrophotographic apparatus, and a process cartridge and an electrophotographic apparatus.

A charging member that abuts a photosensitive member to charge the photosensitive member is generally configured so as to have a rubber-containing elastic layer in order that an abutment nip between the photosensitive member and the charging member may be sufficiently and uniformly secured. Since such an elastic layer ineluctably contains a low-molecular weight component, the low-molecular weight component may bleed toward the surface of the charging member due to long-term use of the charging member to contaminate the surface of the photosensitive member. To respond to such a problem, Japanese Patent Application Laid-Open No. 2001-173641 proposes a configuration in which the peripheral surface of an elastic layer is coated with an inorganic oxide coating film or an inorganic-organic hybrid coating film to suppress the bleeding of a low-molecular weight component toward the surface of a charging member.

By the way, in association with an increase in the speed of an electrophotographic image forming process in recent years, the time period for which a photosensitive member and a charging member are in contact with each other has been made relatively short, which is disadvantageous for stable and secure charging of the photosensitive member. It can be said that, under such a circumstance, a charging member having a thick film formed on the peripheral surface thereof, which is intended to suppress the bleeding of a low-molecular weight component, is of a disadvantageous configuration for stable and secure charging of a photosensitive member. In addition, the increase in sliding friction with the photosensitive member abutting the charging member promotes the deposition of bleeding materials from an elastic layer and a surface layer, thereby making it difficult to uniformly charge the photosensitive member over a long period in some cases. Furthermore, since a charge transport layer on the surface of the photosensitive member is easily scraped in association with the increase in sliding friction between the charging member and the photosensitive member, the charge transport layer is required to be formed with having an increased thickness. However, the increase in thickness of the charge transport layer of the photosensitive member results in the reduction in electrostatic capacitance of the charge transport layer, thereby making charge supply from the charging member unstable to cause charging unevenness due to abnormal discharge in some cases.

In order to stably and uniformly charge the photosensitive member, an approach for suppressing abnormal discharge due to local leakage has also been proposed. In order to suppress such charging unevenness due to abnormal discharge, Japanese Patent Application Laid-Open No. 2010-197590 discloses a conductive roller in which an intermediate layer having ion conductivity is provided on an electric resistance adjusting layer, and a surface layer having insulating properties is further provided on the intermediate layer.

### SUMMARY OF THE INVENTION

However, according to studies by the present inventors, with respect to the charging member described in Japanese Patent Application Laid-Open No. 2001-173641, fine electron deficiencies present in the organic-inorganic hybrid film have caused abnormal discharge in some cases. In addition, with respect to the conductive roller described in Japanese Patent Application Laid-Open No. 2010-197590, an ionic substance has bled out at the time of repeatedly outputting an image, thereby making stable and uniform charging difficult in some cases.

The present invention is directed to providing a charging member that can stably charge a body to be charged, and that is hardly changed even in the case of being subjected to forming of an electrophotographic image whose performances are to be maintained over a long period. Further, the present invention is directed to providing an electrophotographic apparatus and a process cartridge that are capable of stably forming a high quality electrophotographic image.

According to one aspect of the present invention, there is provided a charging member comprising a substrate, an elastic layer and a surface layer, wherein the surface layer contains a polymer compound having constitutional units represented by the following general formula (1), chemical formula (2) and general formula (3), and having a Si—O—Ti bond, a Ti—O-M bond and a Si—O-M bond.

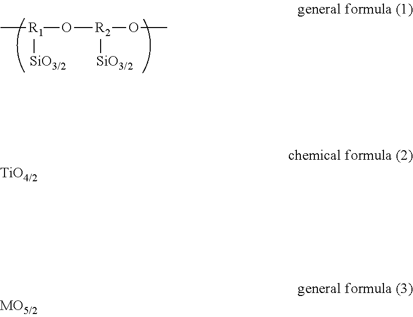

In the general formula (3), M is any atom selected from the group consisting of V, Nb and W. In the general formula (1), R₁ and R₂ each independently represent any of the following general formulae (4) to (7).

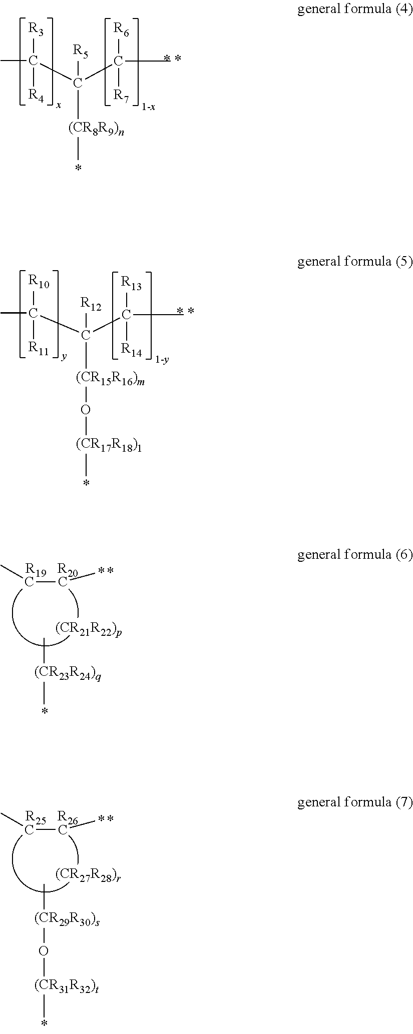

In the formulae, R₃ to R₇, R₁₀ to R₁₄, R₁₉, R₂₀, R₂₅ and R₂₆ each independently represent a hydrogen atom, an alkyl group having 1 to 4 carbon atoms, a hydroxyl group, a carboxyl group, or an amino group. R₈, R₉, R₁₅ to R₁₈, R₂₃, R₂₄ and R₂₉ to R₃₂ each independently represent a hydrogen atom, or an alkyl group having 1 to 4 carbon atoms. R₂₁, R₂₂, R₂₇ and R₂₈ each independently represent a hydrogen atom, an alkoxyl group having 1 to 4 carbon atoms, or an alkyl group having 1 to 4 carbon atoms. n, m, l, q, s and t each independently represent an integer of 1 or more and 8 or less. p and r each independently represent an integer of 4 or more and 12 or less. x and y each independently represent 0 or 1. “*” and “**” represent a binding position to a silicon atom and a binding position to an oxygen atom, respectively, in the general formula (1).

According to another aspect of the present invention, there is provided an electrophotographic apparatus comprising a photosensitive member and the charging member disposed in contact with the photosensitive member.

According to further aspect of the present invention, there is provided a process cartridge comprising a photosensitive member and the charging member disposed in contact with the photosensitive member, the process cartridge being configured to be detachable from a main body of an electrophotographic apparatus.

The present invention can achieve a charging member that suppresses abnormal discharge which causes charging unevenness in an electrophotographic image, and that has little contamination on a surface layer, to thereby enable uniform charging over a long period. In addition, the present invention can achieve a process cartridge and an electrophotographic apparatus that can stably form a high quality electrophotographic image.

Further features of the present invention will become apparent from the following description of exemplary embodiments with reference to the attached drawings.

### BRIEF DESCRIPTION OF THE DRAWINGS

FIG. 1 is a view illustrating one example of a configuration of a charging member according to the present invention.

FIG. 2 is a cross-sectional view illustrating an electrophotographic apparatus equipped with a process cartridge according to the present invention.

FIG. 3 is a view illustrating a ²⁹Si-NMR spectrum.

FIG. 4 is a view illustrating a ¹³C-NMR spectrum.

FIG. 5 is an illustration diagram of a crosslinking reaction in a forming step of a surface layer according to the present invention.

### DESCRIPTION OF THE EMBODIMENTS

Preferred embodiments of the present invention will now be described in detail in accordance with the accompanying drawings

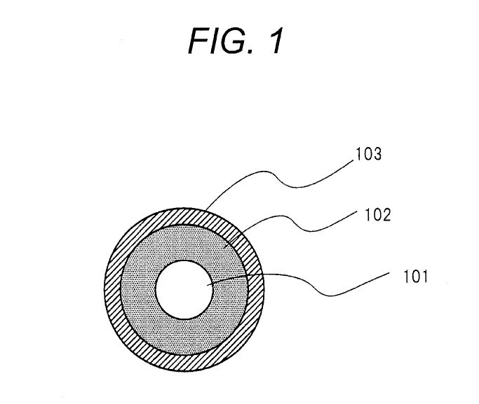

A charging member according to the present invention illustrated in FIG. 1 has a configuration in which a support 101, a conductive elastic layer 102 and a surface layer 103 are laminated in this order.

The charging member is disposed in contact with a photosensitive member to charge (primarily charge) the photosensitive member to a predetermined polarity and potential. A main factor that controls a charge potential in a contact charging manner includes imparting of charge by a discharge phenomenon during high voltage application, injection charging, and imparting of charge by friction charging, but, in general, is predominantly imparting of charge by a discharge phenomenon.

Charging unevenness, namely, potential unevenness in the photosensitive member may be actualized as density unevenness on an electrophotographic image. Therefore, in the charging member, the suppression of abnormal discharge that induces remarkable charging unevenness is an important approach in terms of suppressing the occurrence of density unevenness in an electrophotographic image.

It is also important for suppressing the occurrence of abnormal discharge in use of the charging member over a long period to suppress toner adhesion on the surface of the charging member at the time of repeatedly outputting an image. The reason for this is because a toner adheres on the surface of the charging member to thereby vary the electric resistance value of the charging member as well as a frictional force between the charging member and the photosensitive member, thereby causing charging unevenness. Furthermore, the reason is because an electric field gradient is formed between a region where a toner adheres and a region where no toner adheres on the surface of the charging member to cause electric field concentration, thereby easily inducing abnormal discharge.

In general, the following techniques (1) to (3) are used in order to suppress charging unevenness by abnormal discharge.

(1) An ion conductive substance is used as a conductive substance to suppress unevenness of an electric resistance value distribution.

(2) The electric resistance value of the charging member is increased.

(3) The dispersion of an electron conductive substance such as carbon black in a matrix material such as a rubber is enhanced.

However, in the technique (1), the sliding friction with the photosensitive member is repeated to allow the ion conductive substance to bleed toward the surface, thereby causing charging unevenness in some cases. Furthermore, the surface layer is required to be set to be thick for suppressing the bleeding of the ion conductive substance, and it may be difficult to uniformly charge an electrophotographic photosensitive member. On the other hand, in the technique (2), the rise in electric resistance value increases an electrostatic toner adhesion force, causing charging unevenness by toner adhesion in some cases. In addition, even if the technique (3) is used, abnormal discharge occurs from a local leakage point, and thus the electron conductive substance is required to be uniformly disposed in a three-dimensional direction. Therefore, it may be difficult to suppress abnormal discharge.

Accordingly, the present invention has aimed to simultaneously satisfy the following technical requirements (1) to (3) with respect to the charging member.

(1) Suppression of bleeding.

(2) Suppression of physical and electrostatic adhesion of a toner.

(3) Suppression of local leakage.

Then, the present inventors have focused on the suppression of local leakage through electron deficiencies in the surface layer, and have tried to suppress the occurrence of abnormal discharge under outputting an electrophotographic image at a high speed. As a result, the present inventors have found that the type of an organic metal for constituting the surface layer of the charging member is selected, namely, the following requirements (1) and (2) are satisfied to thereby enable the occurrence of abnormal discharge under outputting an electrophotographic image at a high speed to be significantly suppressed.

(1) A charging member in which at least one surface layer is formed, the surface layer containing a polymer compound having a Si—O—Ti bond, a Ti—O-M bond and a Si—O-M bond.

(2) M is any atom selected from the group consisting of V, Nb and W.

Surface Layer

The surface layer of the charging member according to the present invention contains a polymer compound having a Si—O—Ti bond, a Ti—O-M bond and a Si—O-M bond, and the polymer compound has constitutional units represented by the following general formula (1), chemical formula (2) and general formula (3).

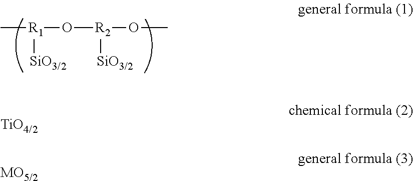

In the general formula (3), M is any atom selected from the group consisting of V, Nb and W. In the general formula (1), R₁ and R₂ each independently represent any of the following general formulae (4) to (7).

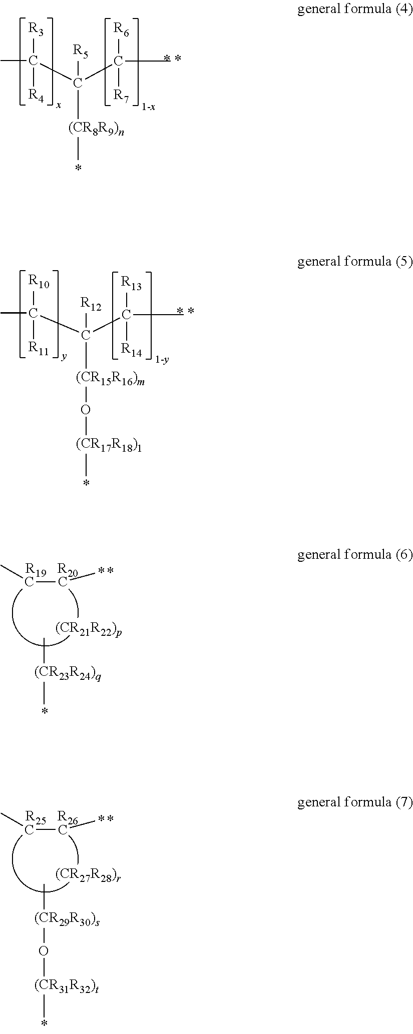

In the formulae, R₃ to R₇, R₁₀ to R₁₄, R₁₉, R₂₀, R₂₅, and R₂₆ each independently represent a hydrogen atom, an alkyl group having 1 to 4 carbon atoms, a hydroxyl group, a carboxyl group, or an amino group. R₈, R₉, R₁₅ to R₁₈, R₂₃, R₂₄, and R₂₉ to R₃₂ each independently represent a hydrogen atom, or an alkyl group having 1 to 4 carbon atoms. R₂₁, R₂₂, R₂₇, and R₂₈ each independently represent a hydrogen atom, an alkoxyl group having 1 to 4 carbon atoms, or an alkyl group having 1 to 4 carbon atoms. n, m, l, q, s and t each independently represent an integer of 1 or more and 8 or less. p and r each independently represent an integer of 4 or more and 12 or less. x and y each independently represent 0 or 1. “*” and “**” represent a binding position to a silicon atom and a binding position to an oxygen atom, respectively, in the general formula (1).

The charging member, in which a polymer compound having a Si—O—Ti bond, Ti—O—Ti bond and Si—O—Si bond, and a constitutional unit represented by the general formula (1) is used for the surface layer, can stably supply a potential because of having a high dielectric constant, even if the rotation speed of the photosensitive member is increased at the time of printing an image. While it is considered that the polymer compound in the present invention is mostly present in the amorphous state, it is considered that the polymer compound is partially present in the form of a metal oxide to raise the dielectric constant, thereby contributing to the stability of charge potential.

The dielectric constant of a substance is dependent on the magnitude of polarization of atoms for constituting the substance. Since the polarization of atoms is subject to the difference in electronegativity between atoms, it is commonly known that an ionic bond such as a metal-oxygen bond is much stronger than a covalent bond for constituting an organic chain, such as a C—C bond and a C—O bond. Accordingly, the dielectric constant can be controlled by selecting a metal atom, and the potential to be applied to the photosensitive member can be controlled at a high level. However, in particular, an oxygen atom in a metal oxide has such a property as to be easily eliminated from the substance, thereby naturally producing oxygen defects. Oxygen deficiencies act as positive holes (holes) and thus concomitantly produce electron deficiencies according to the following reaction formula (101), and it is considered that the electron deficiencies serve as microscopic leakage sites to trigger abnormal discharge.

O₂(oxygen)+2Vacancy( )oxygen deficiency)+2e(electron) [symbol] 2O₀(eliminated oxygen) Reaction formula (101)

Under the circumstances, the present inventors have intensively studied to suppress abnormal discharge through electron deficiencies in the surface layer. As a result, the present inventors have found that the object of the present invention can be achieved by allowing an M atom to be further present in a polymer compound so that the polymer compound has a Ti—O-M bond and a Si—O-M bond. Herein, the metal atom M in the present invention has the following features (1) to (3).

(1) The polarization between the metal atom M and an oxygen atom is large.

(2) The metal atom M is a metal atom having a high valence of 5.

(3) The difference between the ion radius of M⁵⁺ and the ion radius of Ti⁴⁺ is small.

Although the detailed mechanism is not clear, it is presumed that tetravalent Ti⁴⁺ is substituted with a high pentavalent metal ion according to the following reaction formula (102) to thereby allow excess electrons to compensate for electron deficiencies. As a result, it is presumed that the formation of microscopic leakage sites present on the surface layer is suppressed to thereby exert an effect of suppressing abnormal discharge at a high level.

M₂O₅(metal oxide) [symbol] 2M+5O₀(eliminated oxygen)+2e(electron) Reaction formula (102)

In the polymer compound, it is considered that Ti⁴⁺ is partially substituted with a M⁵⁺ ion having an ion radius close to that of Ti⁴⁺. In a coordination number of 6, ion radii are as follows: Ti⁴⁺→0.745 nm, V⁵⁺→0.680 nm, Nb⁵⁺→0.780 nm, and W⁵⁺→0.740 nm. Any atom selected from the group consisting of vanadium (V), niobium (Nb) and tungsten (W) is required to be used as the metal atom M in the present invention from the above viewpoints. Such a metal atom is used to thereby achieve sufficient polarization between the metal atom and an oxygen atom, and contributes to the enhancement in dielectric constant. Furthermore, Ti⁴⁺ is sufficiently substituted with M⁵⁺ to compensate for electron deficiencies, thereby exerting an effect of suppressing abnormal discharge. If the difference between the ion radius of Ti⁴⁺ and the ion radius of M⁵⁺ is large, Ti⁴⁺ is not substituted with other atom to deposit a different phase in the metal oxide, thereby adversely affecting on the stability of discharge in some cases. The metal atom can be, in particular, a V atom in terms of the formation of polarization between the metal atom and an oxygen atom and the substitutability to Ti⁴⁺. In addition, the ion radius at this time is defined by the literature data of Shannon ion radii at the time of a coordination number of 6.

There is no unevenness of film composition because Si, Ti and M atoms are mixed in a molecular level. Such a characteristic is not realized by only Si and Ti, or by only Si and M, and is unique to the polymer compound in which Si, Ti and M are mutually bound via oxygen.

In addition, since the surface layer contains the metal atom, the surface layer has a low affinity with a toner and can effectively suppress toner adhesion even if an image is repeatedly output. Such a surface layer constituted by the polymer compound is dense, and can suppress the bleeding of a low molecular weight component from the elastic layer even if being formed into a thin film. Furthermore, since the sizes of oxygen defects that randomly occur in the film can be prevented from being larger in association with the formation of a thin film in combination with the substitution with a high-valent metal, thereby exerting an effect of suppressing abnormal discharge through electron deficient portions on the surface layer.

Atom Ratio

The ratio of the number of atoms of silicon to the sum of the numbers of atoms of M and Ti in the polymer compound of the present invention, Si/(M+Ti), is preferably 0.05 or more and 7.0 or less, and more preferably 0.10 or more and 5.0 or less. If this value is 0.05 or more, a coating agent achieves sufficient lifetime and coating stability to enable a uniform coating film to be formed, thereby exerting an effect of suppressing abnormal discharge. In addition, if the ratio is 7.0 or less, the substitution with a high-valent metal is sufficiently performed to impart a sufficient effect of suppressing abnormal discharge.

The ratio of the number of atoms of M to the sum of the numbers of atoms of M and Ti in the polymer compound, M/(M+Ti), is 0.005 or more and 0.95 or less, and in particular, more preferably 0.01 or more and 0.90 or less. The ratio is within this range to allow the substitution with a high-valent metal to be sufficiently performed, enabling abnormal discharge to be further suppressed.

In the polymer compound, R₁ and R₂ in the general formula (1) can be represented by any of the following general formulae (8) to (11). In this case, an organic chain is present to enable the elastic modulus of the surface layer to be controlled, or enable fragility and flexibility properties as film characteristics of the surface layer to be controlled. In addition, the presence of an organic chain structure, in particular, an ether site enhances the bonding ability of the surface layer to the elastic layer, and imparts sufficient flexibility, thereby contributing to the enhancement in potential stability at the time of repeatedly outputting an image at a high speed.

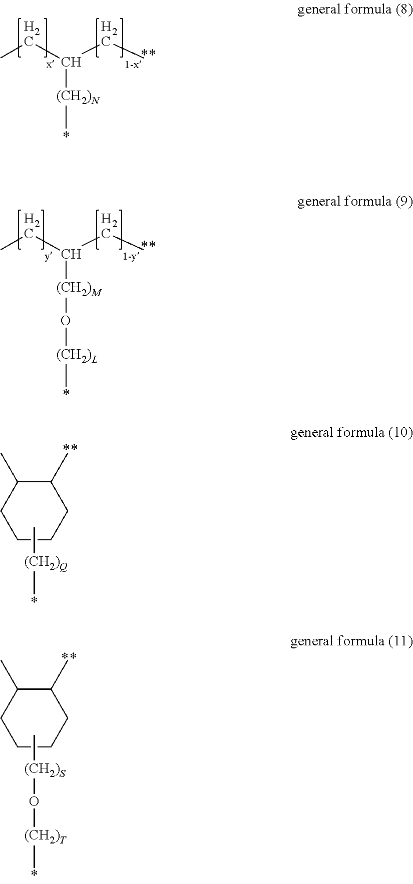

Herein, N, M, L, Q, S, and T each independently represent an integer of 1 or more and 8 or less, and x′ and y′ each independently represent 0 or 1. In addition, “*” and “**” represent a binding position to a silicon atom and a binding position to an oxygen atom, respectively, in the general formula (1).

The polymer compound can be a crosslinked product of a hydrolyzable compound having a structure represented by general formula (12), at least one of hydrolyzable compounds having structures represented by general formulae (14) to (16), and a hydrolyzable compound represented by general formula (13). In the case where such a crosslinked product is used, the material composition of the outermost surface of the charging member can be configured by a single system containing no filler and no particles. Furthermore, the thickness of the surface layer can be made thin.

R₃₃—Si(OR₃₄)(OR₃₅)(OR₃₆) general formula (12)

Ti(OR₃₇)(OR₃₈)(OR₃₉)(OR₄₀) general formula (13)

V(OR₄₉)(OR₅₀)(OR₅₁)(OR₅₂)(OR₅₃) general formula (14)

Nb(OR₄₉)(OR₅₀)(OR₅₁)(OR₅₂)(OR₅₃) general formula (15)

W(OR₄₉)(OR₅₀)(OR₅₁)(OR₅₂)(OR₅₃) general formula (16)

In the general formula (12), R₃₃ represents any of the following general formulae (17) to (20), and R₃₄ to R₃₆ each independently represent an alkyl group having 1 to 4 carbon atoms. In addition, in the general formulae (13) to (16), R₃₇ to R₅₃ each independently represent an alkyl group having 1 to 9 carbon atoms.

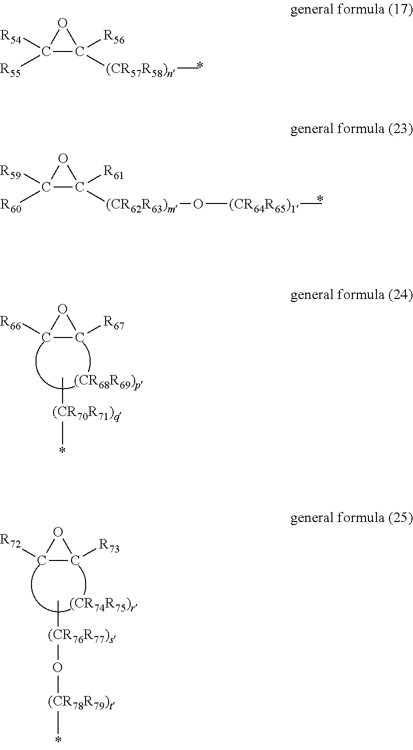

In the general formulae (17) to (20), R₅₄ to R₅₈, R₅₉ to R₆₅, R₆₆, R₆₇, R₇₂ and R₇₃ each independently represent a hydrogen atom, an alkyl group having 1 to 4 carbon atoms, a hydroxyl group, a carboxyl group, or an amino group. R₅₇, R₅₈, R⁶² to R₆₅, R₇₀, R₇₁ and R₇₆ to R₇₉ each independently represent a hydrogen atom, or an alkyl group having 1 to 4 carbon atoms. n′, m′, l′, q′, s′ and t′ each independently represent an integer of 1 or more and 8 or less. p′ and r′ each independently represent an integer of 4 or more and 12 or less. In addition, “*” represents a binding position to a silicon atom in the general formula (12).

Hereinafter, specific examples of the hydrolyzable titanium compound having the structure represented by the general formula (13) are shown. (13-1): titanium methoxide, (13-2): titanium ethoxide, (13-3): titanium n-propoxide, (13-4): titanium i-propoxide, (13-5): titanium n-butoxide, (13-6): titanium t-butoxide, (13-7): titanium i-butoxide, (13-8): titanium nonyloxide, (13-9): titanium 2-ethylhexoxide, (13-10): titanium methoxypropoxide.

Hereinafter, specific examples of the hydrolyzable vanadium compound having the structure represented by the general formula (14) are shown. (14-1): vanadium triethoxideoxide, (14-2): vanadium tri-i-propoxideoxide, (14-3): vanadium tri-n-propoxideoxide, (14-4): vanadium tri-i-butoxideoxide, (14-5): vanadium tri-n-butoxideoxide, (14-6): vanadium tri-sec-butoxideoxide.

Hereinafter, specific examples of the hydrolyzable niobium compound having the structure represented by the general formula (15) are shown. (15-1): niobium methoxide, (15-2): niobium ethoxide, (15-3): niobium n-propoxide, (15-4): niobium i-propoxide, (15-5): niobium n-butoxide, (15-6): niobium i-butoxide, (15-7): niobium sec-butoxide, (15-8): niobium t-butoxide.

Hereinafter, specific examples of the hydrolyzable tungsten compound having the structure represented by the general formula (16) are shown. (16-1): tungsten methoxide, (16-2): tungsten ethoxide, (16-3): tungsten-n-propoxide, (16-4): tungsten i-propoxide, (16-5): tungsten n-butoxide, (16-6): tungsten t-butoxide, (16-7): tungsten 2-ethylhexoxide, (16-8): tungsten 2-methyl-2-butoxide.

Hereinafter, specific examples of the hydrolyzable silane compound having the structure represented by the general formula (17) are shown. (17-1): 4-(1,2-epoxybutyl)trimethoxysilane, (17-2): 4-(1,2-epoxybutyl)triethoxysilane, (17-3): 5,6-epoxyhexyl trimethoxysilane, (17-4): 5,6-epoxyhexyl triethoxysilane, (17-5): 8-oxirane-2-yloctyl trimethoxysilane, (17-6): 8-oxirane-2-yloctyl triethoxysilane.

Hereinafter, specific examples of the hydrolyzable silane compound having the structure represented by the general formula (18) are shown. (18-1): glycidoxypropyltrimethoxysilane, (18-2): glycidoxypropyltriethoxysilane.

Hereinafter, specific examples of the hydrolyzable silane compound having the structure represented by the general formula (19) are shown. (19-1): 2-(3,4-epoxycyclohexyl)ethyl trimethoxysilane, (19-2): 2-(3,4-epoxycyclohexyl)ethyl triethoxysilane.

Hereinafter, specific examples of the hydrolyzable silane compound having the structure represented by the general formula (20) are shown. (20-1): 3-(3,4-epoxycyclohexyl)methyloxypropyl trimethoxysilane, (20-2): 3-(3,4-epoxycyclohexyl)methyloxypropyl triethoxysilane.

R₈₀—Si(OR₈₁)(OR₈₂)(OR₈₃) general formula (21)

In the general formula (21), R₈₀ represents an alkyl group having 1 to 4 carbon atoms, or a phenyl group, and R₈₁ to R₈₃ each independently represent an alkyl group having 1 to 4 carbon atoms.

Hereinafter, specific examples of the hydrolyzable silane compound having the structure represented by the general formula (21) are shown. (21-1): methyltrimethoxysilane, (21-2): methyltriethoxysilane, (21-3): methyltripropoxysilane, (21-4): ethyltrimethoxysilane, (21-5): ethyltriethoxysilane, (21-6): ethyltripropoxysilane, (21-7): propyltrimethoxysilane, (21-8): propyltriethoxysilane, (21-9): propyltripropoxysilane, (21-10): hexyltrimethoxysilane, (21-11): hexyltriethoxysilane, (21-12): hexyltripropoxysilane, (21-13): decyltrimethoxysilane, (21-14): decyltriethoxysilane, (21-15): decyltripropoxysilane, (21-16): phenyltrimethoxysilane, (21-17): phenyltriethoxysilane, (21-18): phenyltripropoxysilane.

In the case where the hydrolyzable silane compound having the structure represented by the general formula (21) is used in combination, a combination of a hydrolyzable silane compound in which R₇₆ has a linear alkyl group having 6 to 10 carbon atoms and a hydrolyzable silane compound in which R₇₆ has a phenyl group can be used. In this case, the combination has a good compatibility with a solvent even if a monomer structure is changed by a hydrolysis-condensation reaction.

Production Example of Polymer Compound

Herein, as a production example of the polymer compound according to the present invention, a method for forming the surface layer on the elastic layer is more specifically described. The polymer compound is produced through the following step (1) to step (6). Herein, a component (A) is the hydrolyzable silane compound of the general formula (12), a component (B) is the hydrolyzable silane compound of the general formula (19), and a component (C) is the hydrolyzable titanium compound of the general formula (13). A component (D) is any one of the hydrolyzable organic metal compounds (M=at least one selected from the group consisting of V, Nb and W) represented by the general formulae (14) to (16).

(1): a step of adjusting the molar ratio of the component (C) and the component (D) to the component (A) and the component (B) {component (C)+component (D)}/{component (A)+component (B)} to 0.1 or more and 5.0 or less.

(2): a step of mixing the components (A) and (B), adding water as a component (E) and an alcohol as a component (F), and then subjecting the resultant to hydrolysis-condensation by heating to reflux.

(3): a step of adding the component (C) and the component (D) to the solution subjected to the hydrolysis-condensation and mixing the components with the solution.

(4): a step of adding a photopolymerization initiator as a component (G), and reducing the concentration of the resulting solution by dilution with the alcohol as the component (F) to provide a coating agent (coating material).

(5): a step of applying the coating agent on the elastic layer formed on the substrate.

(6): a step of subjecting a hydrolyzed condensate to a crosslinking reaction to cure the coating agent.

Herein, the components (A), (B), (C) and (D) may be simultaneously added in step (2). In addition, as the hydrolyzable silane compound, only one kind of the component (A) may be used, two or more kinds of the components (A) may be used in combination, or two or more kinds of the components (B) may be used in combination.

With respect to the amount of water as the component (E) to be added, the molar ratio, component (E)/{component (A)+component (B)}, is preferably 0.3 or more and 7.5 or less, and is further preferably 0.6 or more and 6.0 or less. If this molar ratio is 0.3 or more, condensation sufficiently progresses to form dense crosslinking, and thus the amounts of a low molecular weight substance bleeding out from the elastic layer, and the unreacted remaining monomer are small, thereby enabling toner adhesion to be effectively suppressed. In addition, if this molar ratio is 7.5 or less, the progression of condensation is not so fast, and white turbidity and precipitation are suppressed, thereby contributing to uniform charging. Furthermore, a dense film is uniformly formed, thereby contributing to suppression of abnormal discharge through oxygen defects on the surface layer. In addition, if the amount of water as the component (E) is large, the compatibility with an alcohol and a condensate is deteriorated, thereby easily causing white turbidity and precipitation.

As the alcohol as the component (F), a primary alcohol, a secondary alcohol, a tertiary alcohol, a mixed system of a primary alcohol and a secondary alcohol, or a mixed system of a primary alcohol and a tertiary alcohol can be used. In particular, ethanol, a mixed liquid of methanol and 2-butanol, or a mixed liquid of ethanol and 2-butanol can be used.

As the photopolymerization initiator as the component (G), an onium salt of Lewis acid or Brønsted acid can be used. Examples of other cationic polymerization catalyst include a borate salt, a compound having an imide structure, a compound having a triazine structure, an azo compound, and a peroxide. The photopolymerization initiator can be diluted with a solvent such as an alcohol or a ketone in advance for enhancing the compatibility with the coating agent. The solvent can be methanol or methyl isobutyl ketone. Among various cationic polymerization catalysts, an aromatic sulfonium salt or an aromatic iodonium salt can be used in terms of sensitivity, stability and reactivity. In particular, a bis(4-tert-butylphenyl)iodonium salt, a compound having a structure represented by the following chemical formula (22) (trade name: Adekaoptomer SP150, produced by Asahi Denka Co., Ltd.), or a compound having a structure represented by the following chemical formula (23) (trade name: Irgacure 261, produced by Ciba Specialty Chemicals Inc.) can be used.

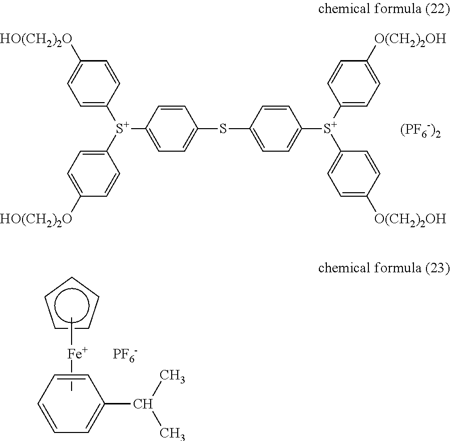

Thickness

The thickness of the surface layer is appropriately 10 to 1000 nm, in particular, 50 to 500 nm. The thickness of the surface layer is within such a range to thereby enable a surface layer having small thickness unevenness to be formed. In addition, the rise in the size of microscopic oxygen defects in the surface layer can be suppressed, and the occurrence of abnormal discharge through oxygen defects can be further surely suppressed. In addition, the increase in electrostatic adhesion force of a toner due to the excess rise in electric resistance value, and the adhesion of a toner in accordance with such an increase can also be suppressed. The volume resistivity of the surface layer is appropriately 10¹⁰ to 10¹⁶ Ω·cm.

Substrate

As the substrate, a conductive substrate is used. Specific examples include the following: metal (alloy) substrates formed by iron, copper, stainless steel, aluminum, an aluminum alloy, or nickel.

Elastic Layer

For the conductive elastic layer, one, or two or more elastomers such as rubbers used for an elastic layer (conductive elastic layer) of a conventional charging member can be used. Rubbers include the following: a urethane rubber, a silicone rubber, a butadiene rubber, an isoprene rubber, a chloroprene rubber, a styrene-butadiene rubber, an ethylene-propylene rubber, a polynorbornene rubber, a styrene-butadiene-styrene rubber, an acrylonitrile rubber, an epichlorhydrin rubber and an alkyl ether rubber.

In addition, a conductive agent can be appropriately used for the conductive elastic layer to thereby make the conductivity of the conductive elastic layer to a predetermined value. The electric resistance value of the conductive elastic layer can be adjusted by appropriately selecting the type and amount used of the conductive agent, and a suitable range of the electric resistance value is 10² to 10⁸Ω and a more suitable range is 10³ to 10⁶Ω. As the conductive agent for the conductive elastic layer, conductive carbon such as Ketjen black EC, acetylene black, carbon for rubber, oxidatively treated carbon for color (ink), and pyrolytic carbon can also be used. In addition, as the conductive agent for the conductive elastic layer, graphite such as natural graphite and artificial graphite can also be used. An inorganic or organic filler, and a crosslinking agent may also be added to the conductive elastic layer.

The hardness of the conductive elastic layer is 60 degrees or more and 85 degrees or less and can be, in particular, 70 degrees or more and 80 degrees or less in MD-1, from the viewpoint of suppressing the deformation of the charging member at the time of allowing the charging member to abut the photosensitive member being a body to be charged.

The conductive elastic layer is formed on the substrate by mixing the raw materials for the conductive elastomer in a closed-type mixer or the like, and subjecting the mixture to a known method such as extrusion molding, injection molding, and compression molding. Herein, the conductive elastic layer is adhered on the substrate via an adhesive, if necessary. The conductive elastic layer formed on the substrate is vulcanized if necessary. A rapid rise in vulcanization temperature allows a volatile by-product such as a vulcanization accelerator in a vulcanization reaction to be gasified, causing voids. Accordingly, a heating zone is separated into two zones, and a first zone can be kept at a lower temperature than the vulcanization temperature to thereby sufficiently evacuate a gas component, and then to perform vulcanization in a second zone.

The surface roughness of the charging member, Rz, is 0.1 μm or more and 25 μm or less and can be in particular 1.0 μm or more and 20 μm or less, from the viewpoints of suppressing the fixation of a toner and an external additive on the surface of the charging member, and suppressing the potential of the electrophotographic photosensitive member.

Formation of Surface Layer

The prepared coating agent is applied on the conductive elastic layer by a technique such as coating using a roll coater, dip coating, and ring coating to form a coating layer. The coating layer is irradiated with activation energy rays to cleave and polymerize a cationic polymerizable group in a silane condensate contained in the coating agent. The silane condensate is thus crosslinked and cured to form the surface layer. A polymer compound obtained by such cationic polymerization has a crosslinked structure represented by the general formula (1), wherein Si atoms bound to an organic group (R₁ or R₂) are bound to other three atoms (Si, Ti, M) via oxygen, respectively.

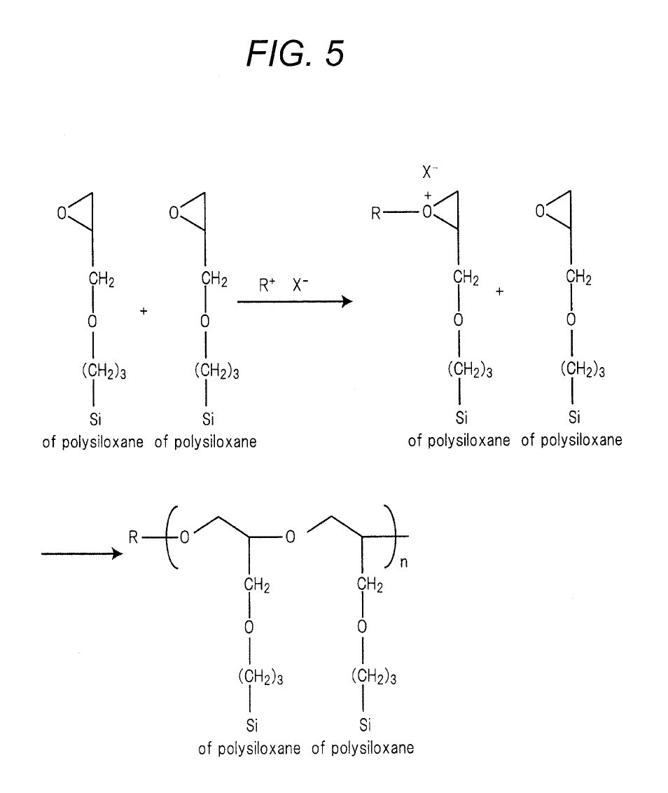

Crosslinking and curing reactions that occur in the process of forming the polymer compound according to the present invention will be specifically described with reference to FIG. 5. For example, a condensate obtained by hydrolyzing 3-glycidoxypropyltrimethoxysilane as the component (A), the component (B), and the component (C) has an epoxy group as a cationic polymerizable group. In such an epoxy group of the hydrolyzed condensate, an epoxy ring is opened in the presence of a cationic polymerization catalyst (designated as R⁺X⁻ in FIG. 5) to advance chain polymerization. As a result, polysiloxane having a Si—O—Ti bond, a Ti—O-M bond and a Si—O-M bond is crosslinked and cured to form the polymer compound according to the present invention.

Ultraviolet rays can be used as activation energy rays. Ultraviolet rays are used for curing the surface layer to hardly generate excess heat, and hardly cause phase separation and wrinkle during the volatilization of a solvent unlike the case of heat curing, thereby providing a very uniform film. Therefore, a uniform and stable potential can be imparted to the photosensitive member.

A high-pressure mercury lamp, a metal halide lamp, a low-pressure mercury lamp, an excimer UV lamp, or the like can be used for the irradiation with ultraviolet rays, and among them, an ultraviolet ray source rich in light having wavelengths of 150 nm or more and 480 nm or less is used. Herein, the integral light quantity of ultraviolet rays is defined as follows.

Ultraviolet ray integral light quantity [mJ/cm²]=ultraviolet ray intensity [mW/cm²]×irradiation time [s]

The ultraviolet ray integral light quantity can be modulated by an irradiation time, lamp output, and a distance between a lamp and a body to be irradiated. The integral light quantity may also have a gradient within the irradiation time. In the case where a low-pressure mercury lamp is used, the ultraviolet ray integral light quantity can be measured by using an ultraviolet ray integral light quantity meter UIT-150-A or UVD-S254 (both are trade names) manufactured by Ushio Inc. In addition, in the case where an excimer UV lamp is used, the ultraviolet ray integral light quantity can be measured by using an ultraviolet ray integral light quantity meter UIT-150-A or VUV-S172 (both are trade names).

Electrophotographic Apparatus and Process Cartridge

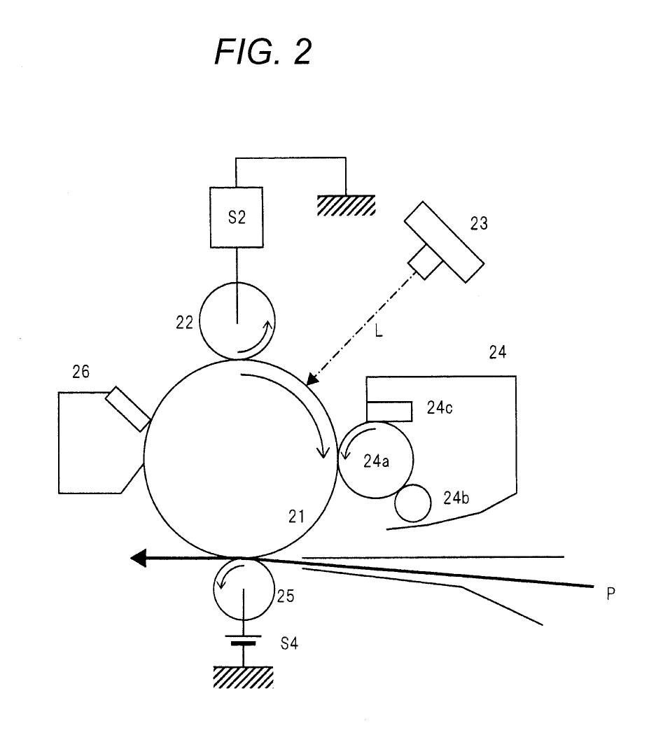

With reference to FIG. 2, a schematic configuration of an electrophotographic apparatus and a process cartridge, in which the charging member of the present invention is used as a charging roller, will be described. A rotating drum-type photosensitive member 21 as an image carrier is rotary-driven at a predetermined peripheral velocity (process speed) in the clockwise direction indicated by an arrow in FIG. 2. For example, a known photosensitive member having at least a roll-shaped conductive substrate and a photosensitive layer containing an inorganic photosensitive material or organic photosensitive material on the substrate may be adopted as the photosensitive member 21. In addition, the photosensitive member 21 may further have a charge injection layer for charging the surface of the photosensitive member to a predetermined polarity and potential.

A charging unit is configured from a charging member 22, and a charging bias-applying power source S2 for applying a charging bias to the charging member 22. The charging member 22 is brought into contact with the photosensitive member 21 by a predetermined pressing force, and, in this example, rotary-driven in the forward direction to the rotation of the photosensitive member 21. A predetermined direct voltage (set to −1050 V in this example) is applied to this charging member 22 from the charging bias-applying power source S2 (DC charging system), thereby subjecting the surface of the photosensitive member 21 to an evenly charging treatment at a predetermined polar potential (dark portion potential is set to −500 V in this example).

A known unit can be utilized as an exposing unit 23, and suitable examples of the exposing unit can include a laser beam scanner. Reference symbol L represents exposing light. The surface of the photosensitive member 21 subjected to the charging treatment is subjected to image exposure corresponding to target image information by the exposing unit 23, thereby selectively reducing (attenuating) an exposure light portion potential (light portion potential is set to −150 V in this example) on the charged surface of the photosensitive member to form an electrostatic latent image on the photosensitive member 21.

A known unit can be utilized as a reversal developing unit.

For example, a developing unit 24 in this example has a toner carrier 24a arranged on the opening portion of a development container for receiving a toner, for carrying and conveying a toner, a stirring member 24b for stirring the received toner, and a toner-regulating member 24c for regulating the thickness of a toner layer on the toner carrier. The developing unit 24 allows a toner (negative toner) charged identical in polarity to the charged polarity of the photosensitive member 21 to selectively adhere to the exposure light portion of the electrostatic latent image on the surface of the photosensitive member 21, thereby visualizing the electrostatic latent image as a toner image (developing bias is set to −400 V in this example). As a development system, a known jumping development system, a contact development system, a magnetic brush system, and the like can be used. In an electrophotographic apparatus for outputting a color image, a contact development system that can improve toner scattering properties can be used.

As a transfer roller 25, for example, a transfer roller obtained by covering a conductive substrate made of a metal or the like with an elastic resin layer whose resistance value is adjusted to a moderate level can be used. The transfer roller 25 is brought into contact with the photosensitive member 21 by a predetermined pressing force, and rotates in the forward direction to the rotation of the photosensitive member 21 at substantially the same peripheral velocity as the rotation peripheral velocity of the photosensitive member 21. In addition, a transfer voltage opposite in polarity to the charging properties of a toner is applied from a transfer bias-applying power source S4. A transfer material P is fed from a sheet-feeding mechanism (not illustrated) to a contact portion between the photosensitive member 21 and the transfer roller at a predetermined timing, and the back surface of the transfer material P is charged so as to be opposite in polarity to the charged polarity of a toner by the transfer roller 25 to which the transfer voltage is applied. Thus, a toner image on the surface side of the photosensitive member 21 is electrostatically transferred to the surface side of the transfer material P at the contact portion between the photosensitive member 21 and the transfer roller.

The transfer material P on which the toner image is transferred is separated from the surface of the photosensitive member, introduced to a toner image fixing unit (not illustrated), and output as an image formed article while having a toner image fixed. In the case of a double-sided image formation mode or a multiple image formation mode, this image formed article is introduced to a recirculation conveying mechanism (not illustrated) to be re-introduced to a transfer portion. A residue on the photosensitive member 21, such as a transfer residual toner, is recovered from the upper portion of the photosensitive member by a cleaning unit 26 such as a cleaning blade. A process cartridge according to the present invention integrally supports the photosensitive member 21 and the charging member 22 according to the present invention, disposed in contact with the photosensitive member 21, and is configured to be detachable from a main body of an electrophotographic apparatus.

### EXAMPLES

Hereinafter, the present invention will be described in more detail with reference to specific Examples. The term “part(s)” in Examples refers to “part(s) by mass.”

<1. Production of Conductive Elastic Roller 1>

The following components shown in Table 1 were mixed in a 6-L pressure kneader (used apparatus: TD6-15MDX, manufactured by Toshin Co., Ltd.) at a filling ratio of 70% by volume and a blade rotation number of 30 rpm for 24 minutes to provide an unvulcanized rubber composition.

TABLE 1

| Raw material | Amount used | |
|---|---|---|
| Medium high nitrile NBR [trade name: Nipol DN219 | 100 | parts |
| (amount of bound acrylonitrile: 33.5%), central value of | | |
| Mooney viscosity: 27, produced by Zeon Corporation] | | |
| Carbon black [trade name: #7360SB, particle | 48 | parts |
| size: 28 nm, nitrogen adsorption specific surface area: | | |
| 77 m²/g, amount of DBP absorbed: 87 cm³/100 g, | | |
| produced by Tokai Carbon Co., Ltd.] (filler) | | |
| Calcium carbonate [trade name: Nanox #30, | 20 | parts |
| produced by Maruo Calcium Co., Ltd.] (filler) | | |
| Zinc oxide | 5 | parts |
| Zinc stearate | 1 | part |

Tetrabenzylthiuram disulfide [trade name: Sanceler TBzTD, produced by Sanshin Chemical Industry Co., Ltd.] (4.5 parts) as a vulcanization accelerator, and 1.2 parts of sulfur as a vulcanizing agent were added to 174 parts by mass of the unvulcanized rubber composition. Then, the resultant was bilaterally cut 20 times in total by an open roll having a roll diameter of 12 inches at a front roll rotation number of 8 rpm, a back roll rotation number of 10 rpm, and a roll interval of 2 mm. Thereafter, the resultant was subjected to tight milling 10 times at a roll interval of 0.5 mm, thereby providing a kneaded product 1 for a conductive elastic layer.

Then, a columnar substrate made of steel having a diameter of 6 mm and a length of 252 mm (having a nickel-plated surface) was prepared. Then, a thermosetting adhesive containing a metal and a rubber (trade name: Metaloc U-20, produced by Toyo Kagaku Kenkyusho Co., Ltd.) was applied to a region extending up to 115.5 mm on both sides each with respect to the center in the axial direction of the columnar surface of the substrate (region having a total width in the axial direction of 231 mm). The resultant was dried at a temperature of 80° C. for 30 minutes, and then further dried at a temperature of 120° C. for 1 hour.

Then, the kneaded product 1 was coaxially extruded into a cylindrical shape having an outer diameter of 8.75 to 8.90 mm using a crosshead extruder on the substrate with an adhesion layer, and ends thereof were cut to produce a conductive elastic roller in which an unvulcanized conductive elastic layer was laminated on the outer periphery of the substrate. An extruder having a cylinder diameter of 70 mm and an L/D of 20 was used as the extruder, and, with respect to temperature modulation at the time of extrusion, the temperature of a head was set to 90° C., the temperature of the cylinder was set to 90° C., and the temperature of a screw was set to 90° C.

Then, the roller was vulcanized using a continuous heating furnace having two zones set to a different temperature from each other. A first zone was set to have a temperature of 80° C. and the roller was passed through the first zone over 30 minutes, and a second zone set to have a temperature of 160° C. and the roller was passed through the second zone over 30 minutes, thereby providing a vulcanized conductive elastic roller.

Then, both ends of the conductive elastic layer portion (rubber portion) of the conductive elastic roller were cut, and thus the width of the conductive elastic layer portion in the axial direction was 232 mm. Thereafter, the surface of the conductive elastic layer portion was ground by a rotary grindstone (rotation number of a workpiece: 333 rpm, rotation number of the grindstone: 2080 rpm, grinding time: 12 seconds). Thus, a conductive elastic roller 1 (conductive elastic roller after surface grinding) was obtained which had a crown shape having a diameter of 8.26 mm at each end and a diameter at the central portion of 8.50 mm, and which had a ten-point average roughness on the surface (Rz) of 5.5 μm, a runout of 18 μm, and a hardness of 73 degrees (MD-1).

The ten-point average roughness (Rz) was herein measured according to JIS B 0601 (1994). The runout was measured using a high-accuracy laser measurement machine, LSM-430v, manufactured by Mitutoyo Corporation. Particularly, the measurement machine was used to measure outer diameters, a difference between the maximum outer diameter and the minimum outer diameter was defined as an outer diameter difference runout, the measurement was performed at five points, and the average of the outer diameter difference runouts at the five points was defined as the runout of a subject to be measured. The measurement of the MD-1 hardness was performed under measurement environments of a temperature of 25° C. and a relative humidity of 55% while the indenter point of an MD-1 type hardness meter (manufactured by Kobunshi Keiki Co., Ltd.) abutting the surface of the measurement subject under a condition of a load of 1000 g.

### Example 1

### 1. Preparation of Condensate 1-1

Then, a condensate for use in forming a surface layer was synthesized.

### Synthesis-1

First, the following components shown in Table 2 were mixed, and then stirred at room temperature for 30 minutes.

TABLE 2

| Raw material | Amount used |
|---|---|
| Glycidoxypropylmethoxysilane (GPTMS, | 42.3 g (0.179 mol) |
| abbreviated as [EP-1], (hydrolyzable silane | |
| compound), [trade name: KBM-403, produced | |
| by Shin-Etsu Chemical Co., Ltd.] | |
| Hexyltrimethoxysilane (HeTMS, abbreviated as | 224.8 g (1.087 mol) |
| [He], (hydrolyzable silane compound), [trade | |
| name: KBM-3063, produced by Shin-Etsu | |
| Chemical Co., Ltd.] | |
| Ion-exchange water | 13.66 g |
| Ethanol [Kishida Chemical Co., Ltd., | 355.26 g |
| special grade] | |

Subsequently, the mixed components were heated to reflux using an oil bath at 120° C. for 20 hours, thereby providing condensate intermediate 1. Condensate intermediate 1 has a theoretical solid content (ratio of the mass of a polysiloxane polymerized product to the total mass of the solution, when all hydrolyzable silane compounds were assumed to be hydrated and condensed) of 28.0% by mass.

### Synthesis-2

Then, 12.659 g (0.0469 mol) of titanium isopropoxide (hereinafter, designated as “Ti-1”) (hydrolyzable titanium compound) [produced by Gelest Inc.], and 0.057 g (0.179 mol) of niobium ethoxide (hereinafter, designated as “Nb-1”) (hydrolyzable niobium compound) [produced by Gelest Inc.] were added to 22.706 g of condensate intermediate 1 cooled to room temperature, and stirred at room temperature for 3 hours to provide final condensate 1-1. Such serial stirring was performed at 250 rpm. The molar ratio of Si:Ti:Nb is 50:49.8:0.2, and Si/(Ti+Nb) is 1.0 and Nb/(Ti+Nb) is 0.004.

### Evaluation 1

### Evaluation of Liquid External Appearance of Condensate

Condensate 1-1 was evaluated for liquid external appearances immediately after the synthesis and after 1 month according to the following criteria. The results are shown in Table 10.

TABLE 3

| Rank | Evaluation criteria |
|---|---|
| A | Liquid neither becomes whitish nor produces precipitate even |
| | after being left to stand for 1 month. |
| B | Liquid becomes whitish after about 2 weeks. |
| C | Liquid becomes whitish after about 1 week. |
| D | Liquid becomes whitish and produces precipitate during synthesis. |

### Evaluation 2

### Evaluation of Chemical Structure of Condensate 1-1

A cured film of condensate 1-1, including a structure represented by formula (1), was confirmed by the following method.

First, 0.7 g of one obtained by diluting an aromatic sulfonium salt [trade name: Adekaoptomer SP-150, produced by Asahi Denka Co., Ltd.] as a photocationic polymerization initiator with methanol to a concentration of 10% by mass was added to 25 g of condensate 1-1. Then, condensate 1-1 was diluted with a mixed liquid of ethanol and 2-butanol (ethanol:2-butanol=1:1) so as to have a theoretical solid content of 7.0% by mass, thereby preparing a diluted liquid of condensate 1-1. The degreased surface of an aluminum sheet having a thickness of 100 μm was spin-coated with the diluted liquid by using a spin-coating apparatus (trade name: 1H-D7, manufactured by Mikasa Co., Ltd.). The spin-coating was performed under conditions of a rotation number of 300 rpm and a rotation time of 2 seconds.

A coating film of the diluted liquid formed on the aluminum sheet was dried, and then the coating film was irradiated with ultraviolet rays having a wavelength of 254 nm so that the integral light quantity reached 9000 mJ/cm², thereby curing the coating film. A low-pressure mercury lamp (manufactured by Harison Toshiba Lighting Corporation) was used for the irradiation with ultraviolet rays. Then, the cured film of the coating film was peeled off from the aluminum sheet and pulverized using a mortar made of agate to be formed into a sample for an NMR measurement. The sample was subjected to ²⁹Si-NMR and ¹³C-NMR measurements by using a nuclear magnetic resonance apparatus (trade name: JMN-EX400, manufactured by JEOL).

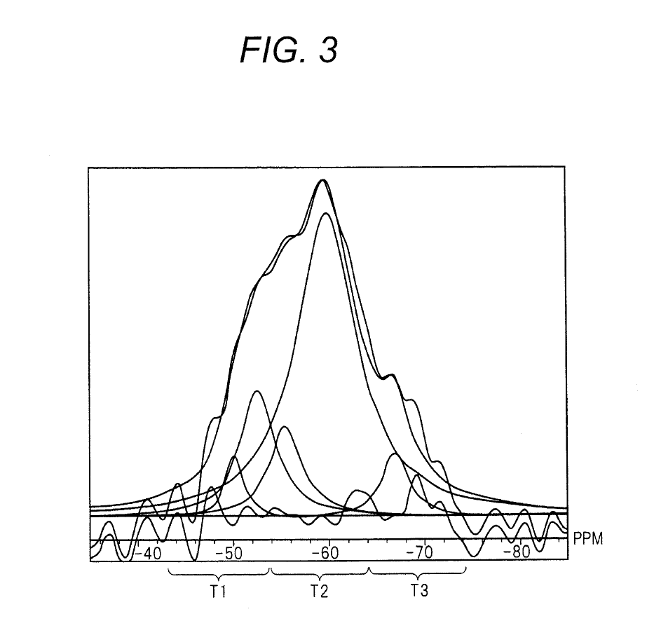

FIG. 3 shows a spectrum obtained by the ²⁹Si-NMR measurement. In the same figure, peaks by waveform separation of the spectrum are shown together. A peak in the vicinities of −64 ppm to −74 ppm shows a T3 component. Herein, the T3 component shows a state in which Si having one bond with an organic functional group has three bonds with other atoms (Si, Ti, M) via O. It was confirmed from FIG. 3 that there was a species present in the state of —SiO_{3/2} by condensation of a hydrolyzable silane compound having an organic chain containing an epoxy group.

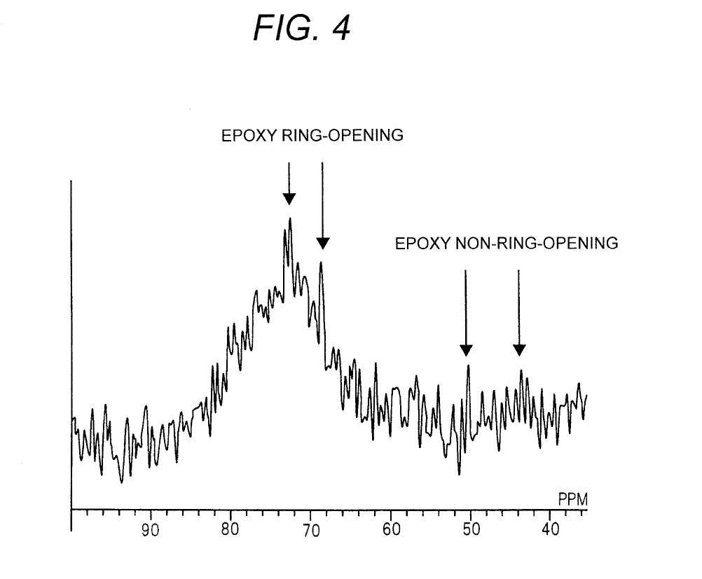

In addition, FIG. 4 shows a spectrum obtained by the ¹³C-NMR measurement. Peaks indicating an epoxy group before ring-opening appeared in the vicinities of 44 ppm and 51 ppm, and peaks after ring-opening polymerization appeared in the vicinities of 69 ppm and 72 ppm. It was confirmed from FIG. 4 that polymerization was performed while almost no ring-unopened epoxy group remaining. It was confirmed from the above ²⁹Si-NMR and ¹³C-NMR that the cured film of condensate 1-1 had a structure of the general formula (1).

<2. Preparation of Coating Material 1-1 for Forming Surface Layer and Production of Charging Roller 1>

Condensate 1-1 was used to prepare a coating material 1-1 for forming a surface layer in the following procedure. That is, 0.7 g of one obtained by diluting an aromatic sulfonium salt [trade name: Adekaoptomer SP-150, produced by Asahi Denka Co., Ltd.] as a photocationic polymerization initiator with methanol to a concentration of 10% by mass was added to 25 g of condensate 1-1. Then, condensate 1-1 was diluted with a mixed liquid of ethanol and 2-butanol (ethanol:2-butanol=1:1) so as to have a solid content of 1.0% by mass, thereby preparing coating material 1-1 for forming a surface layer.

Then, the conductive elastic layer of the previously produced conductive elastic roller 1 (after surface grinding) was ring-coated with coating material 1-1 for forming a surface layer (output rate: 0.120 ml/s, speed of ring portion: 85 mm/s, total output: 0.130 ml). The coating film of coating material 1-1 was irradiated with ultraviolet rays having a wavelength of 254 nm so that the integral light quantity reached 9000 mJ/cm², and thus the coating film of coating material 1-1 was cured to be formed into a surface layer. A low-pressure mercury lamp (manufactured by Harison Toshiba Lighting Corporation) was used for the irradiation with ultraviolet rays. Thus, a charging roller 1 was obtained.

### Evaluation 3

### Coatability Evaluation of Coating material 1-1

The external appearance state of the surface of the charging roller 1 was visually observed, and the coatability of coating material 1-1 was evaluated according to the following criteria shown in Table 4. The evaluation results are shown in Table 10.

TABLE 4

| Rank | Evaluation criteria |
|---|---|
| A | No coating unevenness is seen at all on the surface of |
| | charging roller. |
| B | Coating unevenness has occurred on part of the surface |
| | of charging roller. |
| C | Remarkable coating unevenness has occurred on the whole |
| | region of the surface of charging roller. |

### Evaluation 4

### Identification of Si—O—Ti, Si—O-M, and Ti—O-M Bonds

Subsequently, the presences of a Si—O—Ti bond, a Si—O—Nb bond and a Ti—O—Nb bond in the surface layer of the charging roller 1 were identified using ESCA (trade name: Quantum 2000, manufactured by Ulvac-Phi Inc.). That is, the surface of the charging roller 1 was so made as to be irradiated with X-rays to evaluate the mode of the bonds in the surface layer. The presences of a Si—O—Ti bond, a Si—O—Nb bond and a Ti—O—Nb bond were identified from the detected O1s spectrum.

### Evaluation 5

### Durability Evaluation of Charging Performance of Charging Roller 1

The durability of the charging performance of the charging roller 1 was evaluated by the following method. A laser beam printer used for image evaluation was a reconstructed one in which the feeding speed of the recording medium of a commercially available laser beam printer (trade name: LBP7200CN, manufactured by Canon Inc.) was reconstructed to be 32 ppm.

First, the charging roller 1 and the photosensitive member were mounted to a process cartridge “trade name: Toner cartridge 318 (black), manufactured by Canon Inc.” for integrally supporting themselves, and left to stand under a high-temperature and high-humidity environment (temperature: 40° C., relative humidity: 95%) for 1 month. It is to be noted that the long-time storage in a high-temperature and high-humidity environment is a disadvantageous condition for bleeding because the molecular mobility of a low molecular weight component remaining in the charging roller is increased. Thereafter, the resultant was left to stand in environments of a temperature of 15° C. and a relative humidity of 10% for 72 hours, and then the process cartridge was mounted to the reconstructed laser beam printer.

It is to be noted that the photosensitive member is an organic photosensitive member having an organic photosensitive layer having a thickness of 22.0 μm formed on a support. The organic photosensitive layer is formed so as to have a thicker thickness in association with the reconstruction of the laser beam printer. In addition, the organic photosensitive layer is a laminate-type photosensitive layer having a charge generation layer and a charge transport layer containing polyarylate (binding resin) laminated from the support side, and the charge transport layer serves as the surface layer of the photosensitive member.

The output of the electrophotographic image was performed in environments of a temperature of 15° C. and a relative humidity of 10%. The output electrophotographic image was formed so that an alphabet letter “E” having a size of 4 points was printed on A4-size paper at a print percentage of 0.5%. Hereinafter, the electrophotographic image is referred to as “E-letter image.”

In addition, the process speed was set to 154.0 mm/s. When the electrophotographic image is formed in a continuous mode under such a high speed output, charge is required to be stably supplied to the photosensitive member. Therefore, such a process speed condition is a more stringent evaluation condition with respect to the evaluation of the presence of the density unevenness due to abnormal discharge on the electrophotographic image.

Then, one halftone image was output with respect to each output of “E-letter image” on 1000 sheets continuously. The halftone image refers to an image having a horizontal line drawn in the perpendicular direction at a width of 1 dot and an interval of 2 dots.

The halftone image was visually observed to evaluate the presence of the density unevenness due to abnormal discharge. It is to be noted that since the occurrence of abnormal discharge on the charging roller makes the potential to be applied to the photosensitive member ununiform, the density unevenness is actualized as scale-like density unevenness on, in particular, the halftone image. Therefore, the presence of the density unevenness due to abnormal discharge on the halftone image was evaluated according to the following criteria shown in Table 5.

In addition, even in the case where remarkable density unevenness due to abnormal discharge occurred on the initially output halftone image, the above evaluation was continuously performed until the number of sheets on which the “E-letter image” was continuously output reached 20000. The results are shown in Table 10.

TABLE 5

| Rank | Evaluation criteria |
|---|---|
| AA | No image unevenness can be seen at all even after 20000 sheets |
| | are continuously printed. |
| A | Scale-like image unevenness can only be seen in a slightly |
| | scattered manner after 15000 or more and less than 20000 sheets |
| | are continuously printed. |
| B | Scale-like image unevenness can only be lightly seen after 10000 |
| | or more and less than 15000 sheets are continuously printed. |
| | Furthermore, after the occurrence of the image unevenness, the |
| | scale-like image disappears before 2000 sheets are continuously |
| | printed. |
| C | Scale-like image unevenness can be seen after 5000 or more and |
| | less than 10000 sheets are continuously printed. Furthermore, |
| | after the occurrence of the image unevenness, the scale-like |
| | image disappears before 2000 sheets are continuously printed. |
| D | Scale-like image unevenness can be clearly seen on the whole |
| | image after less than 5000 sheets are continuously printed. |
| | Furthermore, after the occurrence of the image unevenness, |
| | the scale-like image does not disappear although 2000 sheets |
| | are continuously printed. |

### Evaluation 6

### Evaluation of External Appearance of Roller after Durability Test

After the “E-letter image” was output on 20000 sheets, the charging roller 1 was taken out from the process cartridge, and visually observed to evaluate the degree of contamination on the surface according to the following criteria shown in Table 6. The results are shown in Table 10.

TABLE 6

| Rank | Evaluation criteria |
|---|---|
| A | No contamination can be seen on charging roller. |
| B | Light contamination can be seen on charging roller end |
| | portions alone. |
| C | Contamination can be seen on charging roller end portions alone. |
| D | Contamination can be seen on the whole charging roller. |

### Example 2 to Example 50

### 1. Preparation of Condensate Intermediates 2 to 9

Condensate intermediates 2 to 9 were prepared in the same manner as in condensate intermediate 1 except that the component (A) and the component (B) as well as the amounts used were changed as shown in Table 7. Herein, symbols such as “EP-1” in Table 7 represent compounds shown in Table 8, respectively.

TABLE 7

| Condensate | Amount added/g | | | | | | | | Molar ratio |
|---|---|---|---|---|---|---|---|---|---|
| intermediate | Component (A) | | | | Component (B) | | | | of water added |
| No. | EP-1 | EP-2 | EP-3 | EP-4 | He | Ph | Water (E) | EtOH | (E)/{(A) + (B)} |
| 1 | 42.30 | — | — | — | 224.8 | — | 13.66 | 355.26 | 0.60 |
| 2 | — | 35.99 | — | — | 235 | | 14.28 | 350.7 | |
| 3 | — | — | 54.89 | — | 216.1 | — | 13.13 | 351.88 | |
| 4 | — | — | — | 43.72 | 222.5 | — | 13.52 | 356.28 | |
| 5 | 44.47 | — | — | — | — | 275.8 | 14.36 | 301.42 | |
| 6 | 42.30 | — | — | — | 224.8 | — | 6.55 | 358.66 | 0.30 |
| 7 | | — | — | — | | — | 32.74 | 332.47 | 1.50 |
| 8 | | — | — | — | | — | 130.95 | 234.26 | 6.00 |
| 9 | | — | — | — | | — | 163.68 | 201.52 | 7.50 |

TABLE 8

| Abbreviation | Name | Structure | Manufacturer | MW | Concentration |
|---|---|---|---|---|---|
| EP-1 | 3-Glycidoxypropyltrimethoxy- silane | 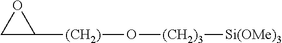 | Shin-Etsu Chemical Co., Ltd. | 236 | 100% |
| EP-2 | 4-(1,2-Epoxybutyl)trimethoxy- silane | 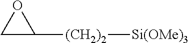 | Carbone Scientific | 192 | 100% |
| EP-3 | 8-Oxirane-2-yloctyltriethoxy- silane | 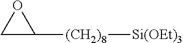 | SiKÉMIA | 319 | 100% |
| EP-4 | 1-(3,4- Epoxycyclohexyl)ethyltrimeth- oxysilane | 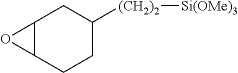 | Shin-Etsu Chemical Co., Ltd. | 246 | 100% |
| He | Hexyltrimethoxysilane | H₃C—(CH₂)₅—Si(OMe)₃ | Shin-Etsu Chemical Co., | 206 | 100% |
| | | | Ltd. | | |
| Ph | Phenyltriethoxysilane | 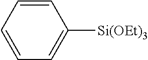 | Shin-Etsu Chemical Co., Ltd. | 240 | 100% |
| Ti-1 | Titanium isopropoxide | Ti—(OⁱPr)₄ | Kojundo Chemical | 284 | 99% |
| | | | Laboratory Co., Ltd. | | |
| Ti-2 | Titanium n-nonyloxide | Ti—(OnC₉H₁₉)₄ | gelest | 621 | 95% |
| Nb-1 | Niobium ethoxide | Nb(OEt)₅ | gelest | 318 | 100% |
| V-1 | Vanadium(V) triethoxideoxide | VO(OEt)₃ | Kojundo Chemical | 202 | 100% |
| | | | Laboratory Co., Ltd. | | |
| V-2 | Vanadium(V) tri-i-propoxide- | VO(O—i-Pr)₃ | Kojundo Chemical | 244 | 100% |
| | oxide | | Laboratory Co., Ltd. | | |
| W-1 | Tungsten ethoxide | W(OEt)₅ | gelest | 409 | 100% |

*Me: methyl group, Et: ethyl group, Pr: propyl group

### 2. Preparation of Condensates 1-2 to 1-26

Condensates 1-2 to 1-26 were prepared in the same manner as in the condensate 1-1 except that condensate intermediate 1, the component (C) and the component (D) as well as the amounts used were changed as shown in Table 9. The atomic ratio of each condensate is shown in Table 9. In addition, each condensate was subjected to Evaluation 2. As a result, it was confirmed that the structure represented by the general formula (1) was contained in the cured film of each condensate.

### 3. Preparation of Condensates 2-1 to 2-6, Condensates 3-1 to 3-6, Condensates 4-1 to 4-6, Condensates 5-1 to 5-2, and Condensates 6 to 9

Condensates 2-1 to 2-6, condensates 3-1 to 3-6, condensates 4-1 to 4-6, condensates 5-1 to 5-2, and condensates 6 to 9 were prepared in the same manner as in condensate 1-1 except that the types of the condensate intermediate, the component (C) and the component (D), as well as the amounts used were changed as shown in Table 9. The atomic ratio of each condensate is shown in Table 9. In addition, each condensate was subjected to Evaluation 2. As a result, it was confirmed that the structure represented by the general formula (1) was contained in the cured film of each condensate.

### 4. Preparation of Coating Material for Forming Surface Layer

Instead of condensate 1-1, each of condensates 1-2 to 1-26, condensates 2-1 to 2-6, condensates 3-1 to 3-6, condensates 4-1 to 4-6, condensates 5-1 to 5-2, and condensates 6 to 9 was used. In addition, with respect to condensates 1-23 to 1-26, the solid content concentrations (the concentrations of condensates in coating materials) were 0.01%, 2.0%, 5.0%, and 6.0%, respectively. Coating materials 1-2 to 1-26 for forming a surface layer, coating materials 2-1 to 2-6 for forming a surface layer, coating materials 3-1 to 3-6 for forming a surface layer, coating materials 4-1 to 4-6 for forming a surface layer, coating materials 5-1 to 5-2 for forming a surface layer, and coating materials 6 to 9 for forming a surface layer were prepared in the same manner as in coating material 1-1 for forming a surface layer except for the above conditions. The concentration of the condensate in each of the coating materials was indicated as the “solid content after dilution” in Table 9.

### 5. Production and Evaluation of Charging Roller

Instead of coating material 1-1 for forming a surface layer, each of coating materials 1-2 to 1-26 for forming a surface layer, coating materials 2-1 to 2-6 for forming a surface layer, coating materials 3-1 to 3-6 for forming a surface layer, coating materials 4-1 to 4-6 for forming a surface layer, coating materials 5-1 to 5-2 for forming a surface layer, and coating materials 6 to 9 for forming a surface layer was used. In addition, the thickness of the surface layer was set to each thickness shown in Table 10. Charging rollers 2 to 50 were produced in the same manner as in the charging roller 1 except for the above conditions, and were subjected to Evaluation 3 to Evaluation 6. The evaluation results are shown in Table 10.

TABLE 9

| | Condensate | | Amount added/g | | | | | | | | |
|---|---|---|---|---|---|---|---|---|---|---|---|
| | intermediate | | Component | | | | | | Atomic ratio | | |
| Condensate | | Amount | (C) | | Component (D) | | | | M/ | Si/ | Solid content |
| No. | No. | added/g | Ti-1 | Ti-2 | Nb-1 | V-1 | V-2 | W-1 | (Ti + M) | (Ti + M) | after dilution |
| 1-1 | 1 | 22.705 | 12.639 | — | 0.057 | — | — | — | 0.004 | 1.0 | 1.0% |
| 1-2 | | 22.705 | 12.626 | — | 0.071 | — | — | — | 0.005 | | |
| 1-3 | | 22.705 | 12.6405 | — | 0.143 | — | — | — | 0.01 | | |
| 1-4 | | 22.705 | 11.4915 | — | 1.430 | — | — | — | 0.10 | | |
| 1-5 | | 22.705 | 6.384 | — | 7.148 | — | — | — | 0.50 | | |
| 1-6 | | 22.705 | 1.277 | — | 12.866 | — | — | — | 0.90 | | |
| 1-7 | | 22.705 | 1.0215 | — | 13.152 | — | — | — | 0.92 | | |
| 1-8 | | 26.427 | 14.8025 | — | — | 0.043 | — | — | 0.004 | 1.0 | 1.0% |
| 1-9 | | 26.427 | 14.7875 | — | — | 0.053 | — | — | 0.005 | | |
| 1-10 | | 26.427 | 14.7135 | — | — | 0.106 | — | — | 0.01 | | |
| 1-11 | | 26.427 | 13.3755 | — | — | 1.058 | — | — | 0.10 | | |
| 1-12 | | 26.427 | 7.431 | — | — | 5.287 | — | — | 0.50 | | |
| 1-13 | | 26.427 | 1.486 | — | — | 9.516 | — | — | 0.90 | | |
| 1-14 | | 26.427 | 1.189 | — | — | 9.727 | — | — | 0.92 | | |
| 2-1 | 2 | 22.312 | 13.053 | — | 0.074 | — | — | — | 0.005 | 1.0 | 1.0% |
| 2-2 | | 22.312 | 11.807 | — | 1.469 | — | — | — | 0.10 | | |
| 2-3 | | 22.312 | 1.312 | — | 13.220 | — | — | — | 0.90 | | |
| 2-4 | | 26.088 | 15.262 | — | — | 0.055 | — | — | 0.005 | 1.0 | 1.0% |
| 2-5 | | 26.088 | 13.805 | — | — | 1.091 | — | — | 0.10 | | |
| 2-6 | | 26.088 | 1.534 | — | — | 9.821 | — | — | 0.90 | | |
| 3-1 | 3 | 23.052 | 12.396 | — | 0.070 | — | — | — | 0.005 | 1.0 | 1.0% |
| 3-2 | | 23.052 | 11.2125 | — | 1.395 | — | — | — | 0.10 | | |
| 3-3 | | 23.052 | 1.246 | — | 12.554 | — | — | — | 0.90 | | |
| 3-4 | | 26.725 | 14.371 | — | — | 0.052 | — | — | 0.005 | 1.0 | 1.0% |
| 3-5 | | 26.725 | 12.999 | — | — | 1.028 | — | — | 0.10 | | |
| 3-6 | | 26.725 | 1.4445 | — | — | 9.248 | — | — | 0.90 | | |
| 4-1 | 4 | 22.794 | 12.626 | — | 0.071 | — | — | — | 0.05 | 1.0 | 1.0% |
| 4-2 | | 22.794 | 1.421 | — | 1.421 | — | — | — | 0.10 | | |
| 4-3 | | 22.794 | 1.269 | — | 12.786 | — | — | — | 0.90 | | |
| 4-4 | | 26.504 | 14.681 | — | — | 0.053 | — | — | 0.05 | | |
| 4-5 | | 26.504 | 13.280 | — | — | 1.050 | — | — | 0.10 | | |
| 4-6 | | 26.504 | 1.476 | — | — | 9.447 | — | — | 0.90 | | |
| 5-1 | 5 | 22.244 | 11.863 | — | 1.476 | — | — | — | 0.10 | 1.0 | 1.0% |
| 5-2 | | 26.029 | 13.881 | — | — | 1.097 | — | — | | | |
| 1-15 | 1 | 22.244 | — | 25.910 | 1.476 | — | — | — | 0.10 | 1.0 | 1.0% |
| 1-16 | | 26.029 | — | 30.318 | — | 1.097 | — | — | | | |
| 1-17 | 1 | 24.519 | 13.076 | — | — | — | 1.248 | — | 0.10 | 1.0 | 1.0% |
| 1-18 | | 19.970 | 10.650 | — | — | — | — | 1.703 | | | |
| 1-19 | 1 | 4.111 | 41.611 | — | 3.289 | — | — | — | 0.10 | 0.1 | 1.0% |
| 1-20 | | 7.400 | 37.450 | — | 2.960 | — | — | — | | 0.1 | |
| 1-21 | | 34.260 | 3.468 | — | 0.274 | — | — | — | | 5.0 | |
| 1-22 | | 35.000 | 2.531 | — | 0.200 | — | — | — | | 7.0 | |
| 1-23 | 1 | 22.705 | 11.492 | — | 1.430 | — | — | — | 0.10 | 1.0 | 0.01% |
| 1-24 | | | | — | | — | — | — | | | 2.0% |
| 1-25 | | | | — | | — | — | — | | | 5.0% |
| 1-26 | | | | — | | — | — | — | | | 6.0% |
| 6 | 6 | 22.705 | 11.492 | — | 1.430 | — | — | — | 0.10 | 1.0 | 1.0% |
| 7 | 7 | | | — | | — | — | — | | | |
| 8 | 8 | | | — | | — | — | — | | | |
| 9 | 9 | | | — | | — | — | — | | | |

TABLE 10

| | | Coating | | | | | Evaluation 5 | | Evaluation 6 |
|---|---|---|---|---|---|---|---|---|---|
| | | material No. for | Thickness of | Evaluation 1 | | Evaluation 4 | | Number of | Roller external |
| | Charging | forming surface | surface | Liquid | | Presence or | Evaluation of | sheets upon | appearance |
| | roller | layer | layer | external | Evaluation 3 | absence of | abnormal | abnormal | after |
| Example | No. | No. | (nm) | appearance | Coatability | each bond | discharge | discharge | endurance |
| 1 | 1 | 1-1 | 50 | A | A | Present | C | 8000 | C |
| 2 | 2 | 1-2 | 50 | A | A | Present | B | 10000 | B |
| 3 | 3 | 1-3 | 50 | A | A | Present | A | 16000 | A |
| 4 | 4 | 1-4 | 50 | A | A | Present | AA | None | A |
| 5 | 5 | 1-5 | 50 | A | A | Present | AA | None | A |
| 6 | 6 | 1-6 | 50 | A | A | Present | B | 14000 | A |
| 7 | 7 | 1-7 | 50 | A | A | Present | C | 9000 | B |
| 8 | 8 | 1-8 | 50 | A | A | Present | B | 11000 | A |
| 9 | 9 | 1-9 | 40 | A | A | Present | A | 17000 | A |
| 10 | 10 | 1-10 | 50 | A | A | Present | AA | None | A |
| 11 | 11 | 1-11 | 50 | A | A | Present | AA | None | A |
| 12 | 12 | 1-12 | 50 | A | A | Present | AA | None | A |
| 13 | 13 | 1-13 | 50 | A | A | Present | A | 16000 | B |
| 14 | 14 | 1-14 | 60 | A | A | Present | B | 13000 | B |
| 15 | 15 | 2-1 | 50 | A | A | Present | B | 10000 | C |
| 16 | 16 | 2-2 | 50 | A | A | Present | AA | None | A |
| 17 | 17 | 2-3 | 50 | A | A | Present | B | 12000 | B |
| 18 | 18 | 2-4 | 50 | A | A | Present | B | 14000 | B |
| 19 | 19 | 2-5 | 50 | A | A | Present | AA | None | A |
| 20 | 20 | 2-6 | 40 | A | A | Present | A | 18000 | B |
| 21 | 21 | 3-1 | 40 | A | A | Present | B | 11000 | C |
| 22 | 22 | 3-2 | 50 | A | A | Present | AA | None | A |
| 23 | 23 | 3-3 | 50 | A | A | Present | B | 12000 | C |
| 24 | 24 | 3-4 | 50 | A | A | Present | B | 14000 | A |
| 25 | 25 | 3-5 | 50 | A | A | Present | AA | None | A |
| 26 | 26 | 3-6 | 50 | A | A | Present | A | 19000 | A |
| 27 | 27 | 4-1 | 60 | A | A | Present | B | 12000 | A |
| 28 | 28 | 4-2 | 50 | A | A | Present | AA | None | A |
| 29 | 29 | 4-3 | 50 | A | A | Present | C | 8000 | A |
| 30 | 30 | 4-4 | 50 | A | A | Present | C | 7000 | B |
| 31 | 31 | 4-5 | 50 | A | A | Present | AA | None | A |
| 32 | 32 | 4-6 | 50 | A | A | Present | B | 13000 | B |
| 33 | 33 | 5-1 | 50 | A | A | Present | AA | None | A |
| 34 | 34 | 5-2 | 50 | A | A | Present | AA | None | A |
| 35 | 35 | 1-15 | 60 | A | A | Present | AA | None | A |
| 36 | 36 | 1-16 | 50 | A | A | Present | AA | None | A |
| 37 | 37 | 1-17 | 50 | A | A | Present | AA | None | A |
| 38 | 38 | 1-18 | 50 | A | A | Present | AA | None | A |
| 39 | 39 | 1-19 | 40 | A | B | Present | C | 9000 | B |
| 40 | 40 | 1-20 | 50 | A | B | Present | B | 11000 | B |
| 41 | 41 | 1-21 | 60 | A | A | Present | B | 12000 | A |
| 42 | 42 | 1-22 | 70 | A | A | Present | C | 7000 | A |
| 43 | 43 | 1-23 | 10 | A | A | Present | A | 16000 | C |
| 44 | 44 | 1-24 | 120 | A | A | Present | AA | None | A |
| 45 | 45 | 1-25 | 500 | A | B | Present | B | 11000 | A |
| 46 | 46 | 1-26 | 600 | A | B | Present | C | 8000 | A |
| 47 | 47 | 6 | 50 | A | A | Present | B | 14000 | C |
| 48 | 48 | 7 | 50 | B | A | Present | AA | None | A |
| 49 | 49 | 8 | 60 | B | A | Present | AA | None | A |
| 50 | 50 | 9 | 60 | C | A | Present | A | 16000 | B |

### Comparative Example 1

Condensate intermediate 1 in Example 1 was prepared as condensate C-1. Condensate C-1 was subjected to Evaluation 1. The results are shown in Table 12. In addition, it was confirmed from the method of Evaluation 2 that the structure represented by the general formula (1) was present in the cured film of condensate C-1.

Then, coating material C-1 for forming a surface layer was prepared by the same method as the preparation method of coating material 1-1 for forming a surface layer described in Example 1 except that condensate 1-1 was changed to condensate C-1 in Example 1. Then, a charging roller C-1 was produced by the same method as the production method of the charging roller 1 described in Example 1 except that coating material C-1 was used, and was subjected to Evaluations 3, 5 and 6. Herein, the component (C) and the component (D) were not used as raw materials for condensate C-1, and thus Evaluation 4 was not performed. The evaluation results are shown in Table 12.

### Comparative Example 2 to Comparative Example 5

Condensates C-2 to C-5 were prepared by the same method as the method described in “Synthesis-2” of Example 1 except that the types and amounts used of the component (C) and component (D), as well as the amounts of water and ethanol used were changed as shown in Table 11. Condensates C-2 to C-5 were subjected to Evaluation 1. In addition, the component (A) and the component (B) were not used as raw materials for condensates C-2 to C-5, and thus, whether the structure of the general formula (1) was present or not was not confirmed by the method of Evaluation 2.

Then, coating materials C-2 to C-5 for forming a surface layer were prepared by the same method as the preparation method of coating material 1-1 for forming a surface layer described in Example 1 except that condensate 1-1 was changed to each of condensates C-2 to C-5 in Example 1.

Then, charging rollers C-2 to C-5 were produced by the same method as the production method of the charging roller 1 described in Example 1 except that coating materials C-2 to C-5 were used, and were subjected to Evaluations 3, 5 and 6. Herein, the component (A) was not used as a raw material for condensates C-2 to C-5, and thus Evaluation 4 was not performed. The evaluation results are shown in Table 12.

TABLE 11

| | Amount added/g | | | | | | Solid |
|---|---|---|---|---|---|---|---|
| Con- | Component | | | | | | content |
| densate | (C) | Component (D) | | | | | after |
| No. | Ti-1 | Nb-1 | V-1 | W-1 | Water | EtOH | dilution |
| C-2 | 88.4 | — | — | — | 14.14 | 74.26 | 1.00% |
| C-3 | | 81 | — | — | | | |
| C-4 | — | — | 102 | — | | | |
| C-5 | — | — | — | 68.5 | | | |

TABLE 12

| | | | | | | | | Evaluation 6 |
|---|---|---|---|---|---|---|---|---|
| | | Coating | | | | Evaluation 5 | | Roller |
| | | material No. for | Thickness | Evaluation 1 | | | Number of | external |
| | Charging | forming surface | of surface | Liquid | | Evaluation of | sheets upon | appearance |
| Comparative | roller | layer | layer | external | Evaluation 3 | abnormal | abnormal | after |
| Example | No. | No. | (nm) | appearance | Coatability | discharge | discharge | endurance |
| 1 | C-1 | C-1 | 50 | B | A | D | 4000 | C |
| 2 | C-2 | C-2 | 70 | D | C | D | 1000 | D |
| 3 | C-3 | C-3 | 70 | D | C | D | 1000 | D |
| 4 | C-4 | C-4 | 80 | D | C | D | 1000 | D |
| 5 | C-5 | C-5 | 70 | D | C | D | 1000 | D |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-116564, filed May 22, 2012, which is hereby incorporated by reference herein in its entirety.

What is claimed is:

1. A charging member comprising:
a substrate,
an elastic layer, and
a surface layer, wherein
the surface layer contains a polymer compound having constitutional units represented by the following general formula (1), chemical formula (2) and general formula (3), and having a Si—O—Ti bond, a Ti—O-M bond and a Si—O-M bond: 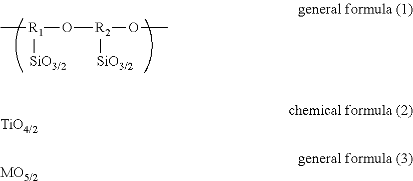
wherein in the general formula (3), M is any atom selected from the group consisting of V, Nb and W; and in the general formula (1), R₁ and R₂ each independently represent any of the following general formulae (4) to (7); 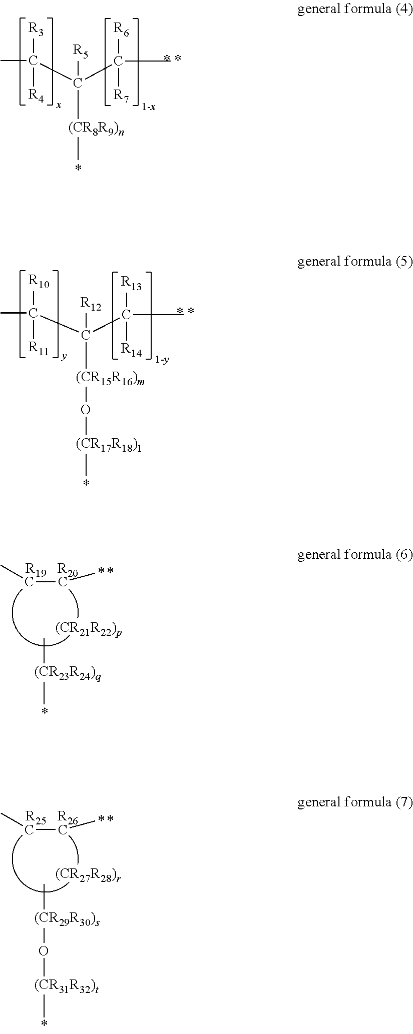
wherein in the general formulae (4) to (7), R₃ to R₇, R₁₀ to R₁₄, R₁₉, R₂₀, R₂₅ and R₂₆ each independently represent hydrogen, an alkyl group having 1 to 4 carbon atoms, a hydroxyl group, a carboxyl group, or an amino group; R₈, R₉, R₁₅ to R₁₈, R₂₃, R₂₄, and R₂₉ to R₃₂ each independently represent hydrogen, or an alkyl group having 1 to 4 carbon atoms; R₂₁, R₂₂, R₂₇, and R₂₈ each independently represent hydrogen, an alkoxyl group having 1 to 4 carbon atoms, or an alkyl group having 1 to 4 carbon atoms; n, m, l, q, s and t each independently represent an integer of 1 or more and 8 or less; p and r each independently represent an integer of 4 or more and 12 or less; x and y each independently represent 0 or 1; and “*” and “**” represent a binding position to a silicon atom and a binding position to an oxygen atom, respectively, in the general formula (1).

2. The charging member according to claim 1, wherein in the polymer compound, R₁ and R₂ in the general formula (1) are each independently any selected from structures represented by the following general formulae (8) to (11): 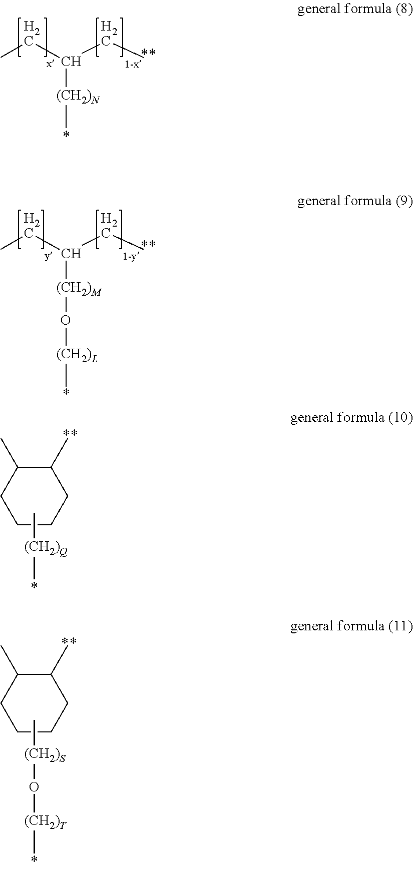
wherein in the general formulae (8) to (11), N, M, L, Q, S and T each independently represent an integer of 1 or more and 8 or less, and x′ and y′ each independently represent 0 or 1; and “*” and “**” represent a binding position to a silicon atom and a binding position to an oxygen atom, respectively, in the general formula (1).

3. The charging member according to claim 1, wherein a ratio of the number of atoms of M to the sum of the numbers of atoms of M and Ti in the polymer compound, M/(M+Ti), is 0.005 or more and 0.95 or less.

4. The charging member according to claim 3, wherein the M/(M+Ti) is 0.01 or more and 0.90 or less.

5. The charging member according to claim 1, wherein a ratio of the number of atoms of silicon to the sum of the numbers of atoms of M and Ti in the polymer compound, Si/(M+Ti), is 0.05 or more and 7.0 or less.

6. The charging member according to claim 5, wherein the Si/(M+Ti) is 0.10 or more and 5.0 or less.

7. The charging member according to claim 1, wherein a thickness of the surface layer is 10 to 1000 nm.

8. The charging member according to claim 7, wherein the thickness of the surface layer is 50 to 500 nm.

9. An electrophotographic apparatus comprising a photosensitive member and a charging member according to claim 1 disposed in contact with the photosensitive member.

10. A process cartridge comprising a photosensitive member and a charging member according to claim 1 disposed in contact with the photosensitive member, the process cartridge being configured to be detachable from a main body of an electrophotographic apparatus.
